(19) United States
(12) Patent Application Publication
(10) Pub. No.: US 2022/0406205 A1
(43) Pub. Date: Dec. 22, 2022

(54) MANAGEMENT OF THE SPATIAL CONGESTION AROUND THE PATH OF A VEHICLE

(71) Applicant: THALES, COURBEVOIE (FR)

(72) Inventors: Marc DA CONCEICAO, TOULOUSE (FR); Frédéric BONAMY, MERIGNAC (FR); François NEFFLIER, TOULOUSE (FR)

(21) Appl. No.: 17/787,567

(22) PCT Filed: Dec. 11, 2020
(86) PCT No.: PCT/EP2020/085785

§ 371 Date: Jun. 20, 2022

(30) Foreign Application Priority Data
Dec. 20, 2019 (FR) FR1915150

(51) Int. Cl. G08G 5/04; G08G 5/00

(52) U.S. Cl. CPC G08G 5/045; G08G 5/0034; G08G 5/0039; G08G 5/0021; G08G 5/0078

(57) ABSTRACT

Devices and methods implemented by a computer for connecting between a human-machine interface (e.g. graphical), supplied with data, in particular traffic and meteorology data, and a system for computing paths (e.g. avionic flight management), for interactive exploration of usable flight paths for managing the spatial congestion around the path of a vehicle are provided. Developments describe the particular case of an aircraft, such as mission management, the gathering of spatial, temporal or technical constraints relating to the spatial congestion within the determined potential airspace, the monitoring of changes in the spatial congestion of the airspace, excursions of the aircraft, miscellaneous displays, and n particular superimposed displays. Various types of human-machine interfaces are described, involving virtual or augmented reality and being configured to display data in 2D, 3D and/or 4D.

### FIELD OF THE INVENTION

The document describes methods and devices for managing paths of an aircraft, or more generally of a vehicle.

### PRIOR ART

Generally, many types of vehicle have path computing systems, which need to be compatible with traffic and/or weather conditions. This concerns almost all types of vehicle: land vehicle (e.g. driverless car), surface vehicle (e.g. boat), submersible vehicle (e.g. submarine), orbital vehicle (e.g. satellite), etc.

In particular, mission preparation for a vehicle, for example for an aircraft, has demanding requirements as regards occupation of or passage through an airspace (one or more volumes for the path movement). A “search and rescue” (SAR) mission “pattern” is known from the prior art, for example. This ladder-shaped pattern scans the space systematically (by sector, in squares, etc.).

A path computing system, for example a flight management system (FMS), aboard the aircraft allows this kind of mission to be defined, these missions also including: drops, air-to-air refuelling (AAR), low-level flight (LLF). The pilot of the aircraft has “FMS pages” (e.g. on-screen displays similar to forms) providing information about the different characteristic elements of these different missions.

The prior art, in particular the patent literature, describes no satisfactory solutions for managing land space, airspace, maritime space or spatial space. This is because, for the most part, the approaches known from the patent literature amount to defining and monitoring a flight corridor of an aircraft around a defined path, in particular in air traffic management or terrain management contexts (e.g. anticipation of collision risks). In the latter cases, the technical solutions described are generally based on fast loops for monitoring the states of the aircraft (between one millisecond and a few seconds). These approaches have limitations (e.g. in particular poor anticipation).

There is a need for systems and methods for advanced management of the congestion in the space around the path of a vehicle.

### SUMMARY OF THE INVENTION

The document describes computer-implemented devices and methods for coupling a (e.g. graphical) human-machine interface supplied with data, in particular traffic and weather data, and a (e.g. avionic flight management) path computing system, for managing the spatial congestion around the path of a vehicle, for the purpose of interactive exploration of usable paths. Developments describe the particular case of an aircraft, such as mission management, gathering of spatial, temporal or technical constraints relating to the spatial congestion within the determined potential airspace, monitoring of movements of the congestion in the airspace, straying by the aircraft, various and in particular superimposed displays. Various types of human-machine interface are described, involving virtual or augmented reality and configured to visually display data in 2D, 3D and/or 4D.

The invention proposes a solution to the need for representing the occupied space (congestion) in order to plan a flight mission, and in order to accomplish it. The invention also proposes a solution for monitoring and warning when this mission is accomplished. The invention proposes a solution to assist in representing the tactical situation or in optimizing or monitoring it.

The invention allows the operator to define and visually display spatiotemporal parameters constraining a mission. The invention allows the operator to obtain information regarding possible noncompliance with the spatiotemporal constraints of his mission. The invention allows the operator to reduce his cognitive load, consisting in taking account of multiple spatial, temporal or technical constraints in order to accomplish and optimize a mission in a constrained space, because of his particular need, and/or because of third-party contingencies (weather certainty, terrain, threat) and/or statutory contingencies (RNP criteria, containment to be guaranteed in the case of a hold).

The prior art describes limited solutions, and in particular does not comprise a human-machine interface for visual display. By way of example, there is no capability in the cockpit of an aircraft allowing (the pilot or an onboard system) to observe the impact of these parameters on the flight space of the mission: passage through an air traffic control border, risk with the terrain, conflict with some kind of area (weather, tactical/military, civil air navigation containment areas, etc.). Therefore, the crew needs to refer to additional information (maps) or additional systems prior to defining, or while accomplishing, the tactical mission. There is a function that takes account of terrain criteria in order to define a flyable low altitude flight profile backed up by guaranteed escape constraints. However, this solution does not allow contextualized information relating to the flight profile in relation to the terrain to be provided in an HMI during flight or in a (EFB- or tablet-type) system connected to the FMS.

There is no known technical solution, in the aeronautical field, allowing: a) visual display of the congestion caused by flight planning; b) monitoring and warning of compliance with this flight space; c) optimization of flyover in the defined space constraints; d) optimization of flyover planned according to constraints related to the parameters of the aircraft or of its detection means. All of these functions need to be performed on a long planning time horizon (prior to flight) up to between a few minutes and a few hours before effective accomplishment with the mission or its associated constraints.

Advantageously, the embodiments of the invention may be applied to different types of mission (e.g. passenger transport, search and rescue, surveillance, etc.), or any other field in which it is necessary to “understand” the occupied space (e.g. satellite maneuvers, movements of fleets of driverless cars, etc.).

Advantageously, the embodiments of the invention may be implemented in onboard avionics (or as a system distributed between the onboard world and the non-onboard world). This is because, in one embodiment, the method or the system according to the invention is based on coupling of a core of the avionic computation (computation of flight plan, path, predictions and possibly guidance), a (e.g. cockpit or non-onboard) human-machine interface and equipment responsible for capturing and representing the congestion for a mission.

Advantageously, the embodiments of the invention may be onboard, taking account of planning and path management. Optionally, non-avionic means may be used (extended system, e.g. connected tablet). Similar applications exist in the case of maritime research missions.

Advantageously, the methods and systems according to the invention may benefit from a connection to third-party systems providing data.

Advantageously, the embodiments of the invention are integrated in avionics referred to as “high-level data integration” avionics (e.g. complex displays integrating multiple data sources, links to weather databases, obstacle databases, threat databases, terrain information databases, etc.).

Advantageously, the method according to the invention allows the pilot of an aircraft to define the space occupied by the mission that he plans, or that he changes, before or during the flight.

Advantageously, the embodiments of the invention allow control of flight missions referred to as “tactical” (e.g. SAR), drone flights (loiter) or else specific civil aviation procedures such as “hold” (holding patterns), departure or arrival procedures having tight path containment constraints (RNP, the abbreviation for Required Navigation Performance).

### DESCRIPTION OF THE FIGURES

Other features and advantages of the invention will become apparent from the description that follows and from the figures of the appended drawings, in which:

FIG. 1 shows examples of steps according to an embodiment of the invention;

FIG. 2 shows an example of “search and rescue” mission management;

FIG. 3 illustrates an exemplary embodiment of the invention, according to a first architecture;

FIG. 4 illustrates an exemplary embodiment of the invention, according to a second architecture.

### DETAILED DESCRIPTION OF THE INVENTION

According to the embodiments of the invention, a “moving body” or “aircraft” may be a drone or a commercial aircraft or an airfreighter or else a helicopter, either carrying or not carrying passengers, or any element capable of being piloted remotely (by radio, satellite or other link), at least in part (intermittently or periodically or even opportunistically over the course of time). The moving body may be a piloted, remotely piloted or unmanned moving body, such as an aircraft (airplane, helicopter or any other aircraft subject to the laws of aeronautics). In other embodiments, the moving body may be terrestrial, surface-based (e.g. boat), submersible (submarine), orbital (satellite), etc.

During the planning of a mission, for example a “search and rescue” mission, the crew of a vehicle may need to know the airspace (2D plane, 3D or even 4D) that will be “occupied” or “used” by the mission that it is planning to accomplish.

There may be various reasons for the mission being needed (e.g. air support, planning and tactical coordination, negotiation with supervisory authorities responsible for the space(s) in question, etc.). The reasons or the needs may arise a priori, that is to say at the time of the initial planning, but may also present themselves a posteriori, that is to say dynamically, during a mission (“replanning” when possible, for example).

According to the embodiments, in the case of an aircraft, the method according to the invention comprises one or more of the steps of:

a) visually displaying one or more airspaces, for example at the time of current events such as flight in a holding pattern (hold), for which statutory spatial containment constraints may exist, or a flight procedure (departure or arrival at an airfield) featuring an “RNP” (Required Navigation Performance) criterion that involves controlling a path within tolerances statutorily defined by air traffic control authorities;
b) integrating predictions determined by a flight computer (“computing core”), for example of FMS type; this integration allows a path factor or a time factor to be taken into account;
c) optionally, taking account of one or more constraints associated with the capabilities of the detection means and/or its installation (laterality, range, angle, etc.); for example, to determine a ladder, it may be advantageous to determine some of the angles or gaps;
d) taking account of one or more constraints associated with the air environment: danger areas (weather, terrain, etc.), controlled areas (air traffic control).

Various examples are described below.

In one embodiment, the operator may choose an RNP procedure; the method according to the invention may rely on data from a navigation database in order to visually translate the RNP constraints (path to be flown and maximum lateral tolerances relating to the RNP procedure).

In one embodiment, the operator may choose to fly in a circle around a given point; the method according to the invention may use the parameters of the circle and of the flight to express the airspace occupied or used (e.g. center, radius, altitude).

In one embodiment, the operator may plan a holding pattern; the method according to the invention may use the data from a navigation database to visually express the volume occupied by this pattern (if it is listed as institutional databases that the operator may have with its FMS, i.e. navigation bases).

In one embodiment, the noise area around an aircraft may be managed or controlled. In the case of an observation drone, visual invisibility may be controlled by way of adequate distance or height, but knowledge of a map of the winds (that “carry” the sound) may play a part in positioning the drone so as to suppress or minimize the noise of its propellers.

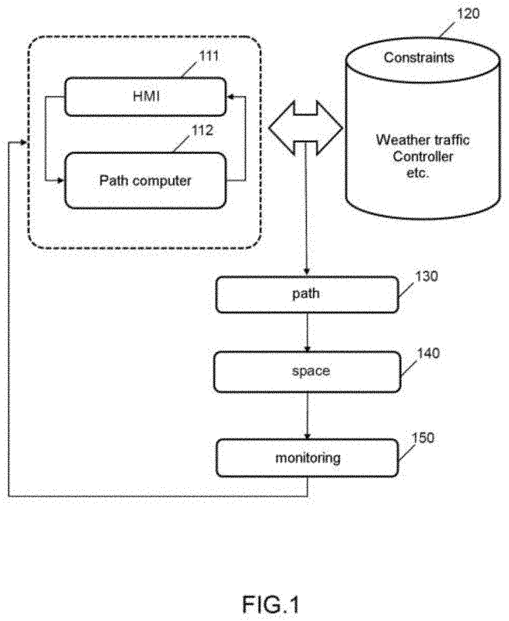

FIG. 1 shows examples of steps according to an embodiment of the invention.

A computer-implemented method is described for coupling a visual or graphical human-machine interface 111 supplied with (for example air) traffic and weather data 120 (thus possibly other types of data, integrating various risks or opportunities) and a path computing system 112, for the purpose of interactive exploration of usable paths, for managing the spatial congestion around the path of a vehicle.

It is important to note that the invention is not limited to management of a “bubble” around the vehicle; indeed, the embodiments of the invention are aimed at managing progress along the path, and in particular the mission pattern (computable or computed future path). The monitoring distances are configurable (in particular on the basis of the speed of the vehicle in the directions in question, plus safety margins), and in particular may move over the course of time (dynamics). To put it another way: the path of the aircraft at an instant t may vary in different ways; the path computations may define the movements by taking account of constraints, and it is a matter of computing the intersection between the potential or even maximum movement space and the traffic and weather conditions (which also change).

The examples that follow deal more with the aeronautical case, but terrestrial, maritime and spatial applications are also in their sights (e.g. driverless car traffic, submarine traffic, tanker traffic, low earth orbit satellite traffic, etc.). The time factor (absolute and relative speeds) may be variable in those cases, along with movements in 2D or 3D, but the management of these vehicles or spatial objects may amount to the same mechanisms described below.

In one particular case (aircraft), a computer-implemented method is described for coupling a visual or graphical human-machine interface 111 supplied with air traffic and weather data 120 and a path computing system 112, for the purpose of interactive exploration of flyable paths, for managing the spatial congestion around the path of the aircraft.

The proposed invention may in particular be based on the coupling of a computing core for flight plan, path, predictions and possibly guidance (FMS) and a (cockpit or non-onboard) HMI.

“Coupling” denotes or translates a two-way or bidirectional relationship. A change made in the path computer e.g. of the FMS (for example a path change) will be visually translated in the human-machine interface; and, conversely, a change introduced by way of the human-machine interface (for example by way of the definition of a prohibited volume) will bring about adaption computations by the path computer.

By way of example, it is possible to assess the consequences of the predicted flight plan/path versus a targeted flyover area.

Beyond the prior art, which only allows visual display of the context of a given mission in a static manner, the embodiments of the invention therefore comprise coupling of a path computer (e.g. an avionic computing core for determining a flight plan, path, predictions and possibly guidance) and an HMI (in the cockpit, on the flight deck, or non-onboard).

In one development, the method further comprises the steps of: firstly, receiving or determining a flight plan 130 of the aircraft, associated with a mission;
determining the potential airspace 140 associated with the flight plan;
secondly, gathering spatial, temporal or technical constraints relating to the spatial congestion within the determined potential airspace;
displaying the received or determined flight plan and the data relating to the spatial congestion in the human-machine interface 111;
determining a flight plan or a flyable path 130 as permitted by the path computer, e.g. avionic flight management system 112, and the associated airspace.

The “utilized airspace” is the airspace mobilized or requested or convened or called upon or associated with a mission of the aircraft (reality recorded a posteriori). The “potential airspace” or “movement geometry” corresponds to the space utilized by the flight plan (wide interpretation; the potential airspace is made to change on the basis of the movements of the aircraft in the space over the course of time). The airspace may be that strictly necessary for the flight plan of the aircraft (e.g. path envelope with tolerance).

The equivalent expressions “utilized spatial space”, “utilized maritime area”, “terrestrial areas of movement” may be used.

In that respect, the invention may rely not only on the definition of a work area but also on the use of a path computer (for example a computing core of flight management system type; computation of flight plan, path and predictions—aircraft performance, speed, altitude, mass) and of a computing core for computing compatibility between the defined space, the (flown) path or simply the position of the vehicle (e.g. the aircraft).

In one development, the method comprises the steps of: adjusting the (e.g. flyable air) space on the basis of interactions received by way of a graphical human-machine interface and/or on the basis of changes of path (or e.g. of flight plan) that are determined in or by a path computer (e.g. an avionic flight management system); and displaying one or more (flown or flyable air) spaces.

In one development, the method further comprises the step of monitoring 140 the movements of the congestion in the space, for example the airspace. The orbits of the opposing satellites may be monitored analogously. The road or maritime traffic may be monitored.

Generally, the geometry in which the aircraft or moving body will move may be defined on the basis of parameters input by the user and/or derived from one or more external systems comprising geometry information, for example flight constraints (detection limits, detection angles, detection distances) and tolerances (lateral and vertical margins). This geometry is the movement geometry of the vehicle (e.g. of the aircraft or “airspace associated with the aircraft”).

This geometry may be provided at the input of a monitoring system (in order to follow or monitor the perimeter movements of the movement geometry of the vehicle) and a warning system (e.g. tracking of straying).

In the aeronautical case, the movement geometry of the aircraft may be provided to a system of FMS type (or external to the FMS) in order to construct a consequently optimized flight plan (detection radius/distance/angle) and a resultant path confined to said geometry.

The movement geometry of the aircraft may be optimized in order to take account of flyover time constraints, constraints of consumed/remaining energy on exiting flyover, sound constraints.

The proposed invention may include a system for monitoring accomplishment of the mission in order to detect and warn of straying from the planned/predicted/flown path in areas.

In one embodiment of the invention, the planning and/or preview may be enhanced by a monitoring and warning system in order to assist in controlling containment, for example in order to take account of tolerances at the limits of the area to be covered, in order to be robust toward any difference between the (static) planning and the predicted path (which is dependent on the flight dynamics, for example an “overshoot” during a turn).

The monitoring may concern in particular one or more intersections (e.g. potential collision) between the determined work area and one or more third-party areas of interest. These collisions may be in particular (potential) collisions with the terrain (e.g. mountains in low altitude flight), collisions with a weather entity, collisions with a reserved third-party space (other work area, exclusion area, enemy area, danger area, etc.), collisions with the planning of another moving body, etc.

In that respect, the invention may rely on a computing core for computing intersections between different geometric entities, and third-party (static or dynamically constructed) data sources.

In one development, the method further comprises the step of warning (a predefined entity, e.g. a server or an organization or a pilot) in the event of the flight of the vehicle or aircraft straying outside the determined airspace.

Conversely, straying of the path during flight outside the defined space may also be monitored. Straying may comprise flying beyond or leaving the determined airspace.

In one development, the method further comprises the step of changing the airspace associated with the aircraft, on the basis of changes of paths of the aircraft and/or on the basis of continuously received data, said data comprising critical weather data, dangerous subairspaces to be avoided or rejoined, safe or authorized subairspaces and/or statutory constraints, in particular RNP-type containment criteria.

The proposed invention is able to interface with third-party systems such as static third-party data source providers (which are “immutable” over a short period: terrain, fixed obstacles) or dynamic third-party data source providers (which are variable over a short period: weather, air traffic control areas, danger areas, military areas).

The geometry of the associated space may be defined statically, on the basis of the parameters input by the operator. The geometry may also be dynamic, that is to say dependent on parameters enhanced by third-party data, continuously.

The proposed invention may take account of the data provided by third-party systems in order to construct a flight plan/path/predictions confined to the authorized/safe spaces (flyable paths, authorized or prohibited orbits, etc.).

In one development, the method also comprises the step of displaying a path and the congestion in the space associated with the path in a superimposed manner.

In one embodiment, the representation comprises a display (e.g. visual superimposition, augmented reality, virtual reality, etc.). In one embodiment, the graphical display is superimposed on the current image (preview).

In one development, the following are displayed in a human-machine interface: one or more of the intermediate computing results concerning in particular a path, and a movement space; and/or information relating to the root causes and/or the computing context of one or more of the steps of the method.

The method according to the invention may comprise one or more feedback loops (e.g. downstream feeding back upstream, feedforward, etc.). A feedback loop may be “closed”, that is to say inaccessible to human control (it is performed by the machine). It may be “open” (e.g. step of display in a human-machine interface, confirmation or any other system of human validation). Various embodiments may arrive at different implementations by closing, or by opening, one or more open loops, or closed loops. For example, the method according to the invention may call upon only open feedback loops (i.e. the pilot intervenes at all stages) or only closed feedback loops (e.g. total automation), or a combination of the two (the human involvement being variable or configurable). In this way, the method (implementing learning or “artificial intelligence” steps) may be interpreted as “transparent”, in the sense of controllable. The display may concern intermediate computation results, information relating to root causes and/or to the computation context. In this way, the method may be considered “explicable”.

A computer program product is described, said computer program comprising code instructions allowing one or more steps of the method to be carried out when said program is executed on a computer.

A system for implementing one or more steps is described, the system comprising: a human-machine interface configured to display lateral and/or vertical information in 2D, 3D or 4D; a flight management system coupled to said human-machine interface.

In one development, the system further comprises a circuit and/or computing and/or memory resources, said resources being local and/or accessed remotely.

For the various fields of application, the invention may form part of either the system used to operate the moving body (for example an onboard avionics suite in the case of an aircraft) or a connected external system allowing the interchange of bidirectional data (examples in the case of an aircraft: a tablet or an EFB connected to the avionics, a ground server connected to the aircraft, etc.).

In the aeronautical case, the invention may be used in a remote cockpit, a virtual or augmented, 3D, touch-controlled, etc., cockpit. The displays in question may therefore be the “navigation display” (lateral display of the flight plan or of the path predicted by the FMS) and/or the “vertical display” (display of the planned vertical profile or of the profile predicted by the FMS). The systems involved may therefore be onboard systems.

In other embodiments, the invention may be implemented in a complete system, for example external to an onboard avionics suite.

In one development, the computing system, e.g. the flight management system, is onboard and avionic, in particular of FMS type, and/or of open world type, in particular of electronic flight bag EFB type.

In one development, the human-machine interface comprises a screen of ND type.

In an onboard avionics context, the proposed invention may be integrated in an ND (navigation display, lateral display) in order to show the space occupied by a tactical mission (for example). The level of integration of the data may be increased (in addition to the tactical information, combining the data, beyond juxtaposing them).

In one development, the human-machine interface comprises one or more, virtual or augmented reality, screens configured to visually display the data in 2D, 3D and/or 4D.

In one development, the system further comprises the use of one or more blockchains and/or smart contract chains configured to manage the air traffic, the weather or the spatial congestion for one or more aircraft.

Optionally, implementation of the invention comprising the use of a blockchain is also possible (and is not an obstacle to the existence of one or more privileged nodes, involving a private cloud or private blockchain). A blockchain allows in particular the sharing of data between entities whose interests are not necessarily aligned or even congruent, while allowing safe recording of flight events (history, traceability, confidence in the data, etc.). For example, a shared blockchain may contain the declared flight plans of the various aircraft moving in a given airspace. Smart contracts performed on a blockchain are able to allow said blockchain to be programmed, and are able to allow in particular safe execution of the programs. For example, the changes of path of the aircraft using one and the same airspace may be negotiated by way of smart contracts accommodated on a blockchain.

In particular, the use of a blockchain may allow the organization of a mission accomplished using several aircraft (for example: fleet of drones) in order to apportion or optimize their mission according to criteria relating to total time for accomplishing the mission, distance between participating aircraft, energy expended (for example: fuel).

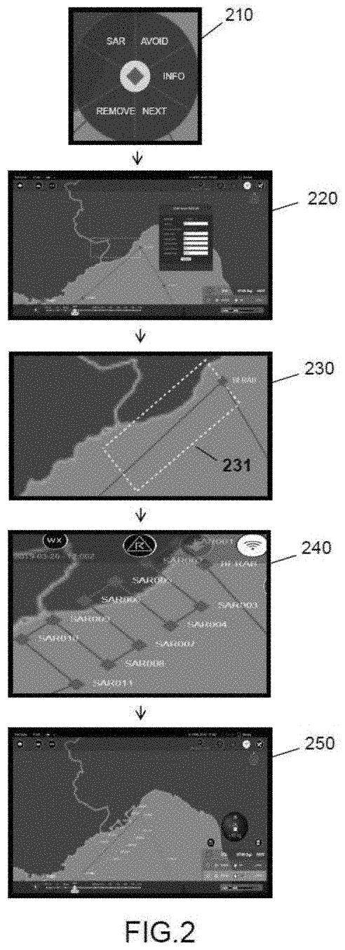

FIG. 2 shows an example of “search and rescue” mission management in an aeronautical context.

In the example illustrated, an operator or a pilot controls a (non-avionic) connected tablet bidirectionally with a path computing system, here a (avionic) flight management system.

In step 210, an operator plans a mission “pattern” from a given point in his mission planning or from any other point. In step 220, the operator determines the various parameters necessary for accomplishing his mission. In the next step 230, the computer presents him with the area in question in dotted lines 231, on the basis of the current parameters. As the pilot or the operator varies the different parameters, the system 240 adapts the area in question in real time. Once the operator is satisfied with the parameters of his mission, he confirms them and the system takes them into account and suggests a corresponding plan/path 250 to him. The operator or the pilot may again accept, reject or change the path. If this planning is satisfactory to him, he can confirm it and it becomes his new work reference.

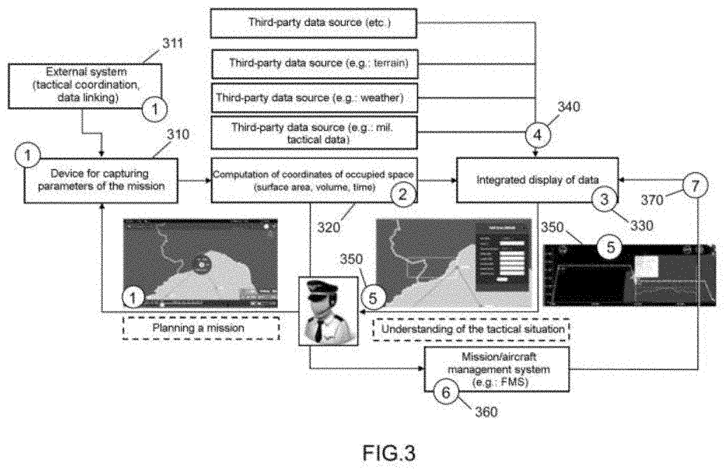

FIG. 3 illustrates an exemplary embodiment of the invention, according to a first architecture.

In step 310, a device captures the parameters of the desired mission. This may be a human-machine interface, abbreviated to HMI, allowing human inputs or entries by way of input peripherals, or a link to external equipment 311. In step 320, a computer determines the occupied geometry corresponding to the parameters that have been input, i.e. determines a utilized airspace (e.g. in terms of surface areas, occupation by sectors, and/or volumes). This geometry may be a polygon approximating the area (for example: square, rectangle, circle), or a more complex and precise polygon (figure having N sides, or more). The geometry may optionally be evolutionary, e.g. associated with temporal parameters (evolving borders, etc.). This geometry may be computed independently of the flight plan that will be constructed on the basis of these same parameters. In step 330, a display device returns the computed information (for example the polygon) to the operator (or to a third-party system, for example on the ground). In step 340, the display device may integrate third-party data in order to increase the understanding of the environment. These third-party data may for example comprise terrain data (e.g. state of landing strips, weather data, tactical data, etc.). In step 350, the operator or the pilot acquaints himself with the information, and changes the parameters as needed (return to step 310). In step 360, if the operator is satisfied, he confirms his parameters in a flight management system. In step 370, the flight management system determines a computation of flight plan, path and predictions corresponding to the chosen constructions. All or some of these data may be displayed in the display system.

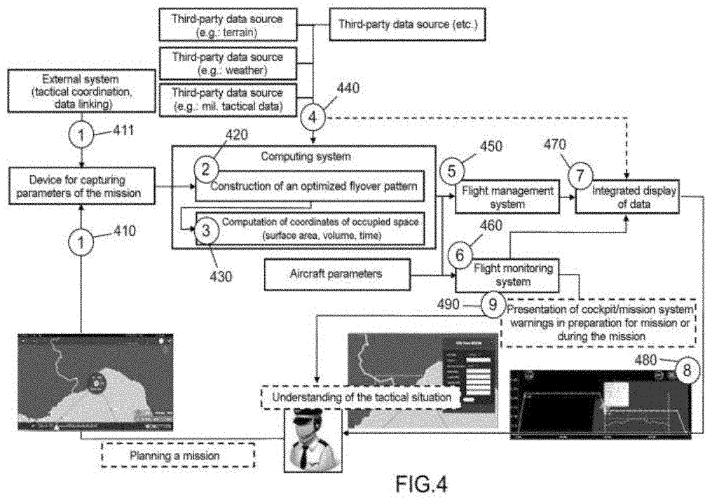

FIG. 4 illustrates an exemplary embodiment of the invention, according to a second architecture.

In step 410, a device captures the parameters of the desired mission. This may be an HMI capturing human inputs, or a link to external equipment 411. In step 420, a device computes a flight plan or a portion of a flight plan that is optimized on the basis of the criteria provided at the input. In step 330, a device computes the corresponding occupied geometry. In step 440, the computing device may integrate third-party data in order to increase the understanding of the environment, and may provide the information for display (weather, terrain, traffic, air areas of interest, danger areas, areas in which flyover is prohibited, etc.). The corresponding data may be managed directly by the client systems of the data and/or may be displayed directly. In step 450, the computed flight plan is communicated to the FMS, which will use it to compute paths and predictions. Feedback (not shown) is possible between the flight management system FMS and the system for computing the optimized flight portion in order to take account of the path and prediction results of the FMS. In step 460, the spatial constraint data derived from third-party sources (or even also derived from 440) are sent to a flight monitoring system. In step 470, a device presents information selected from among: third-party data (visually relevant set or subset, transformed or otherwise), the occupied area, the flight plan and its path optimized for overflying the area, possibly the margins or tolerances taken into account, possibly the predicted projection of the space covered by a detection device, the space taken into account by the flight monitoring system, etc. In step 480, the operator acquaints himself with the constructed mission, and corrects or changes the parameters as needed (return to 410).

If the operator is satisfied, he confirms his parameters in the flight management system. In step 490, the flight monitoring system determines whether the current parameters of the aircraft allow compliance with the constraints obtained at 460 (in preparation for a mission, as in flight). If necessary, a visual, audible, haptic (which relates to the sense of touch) or other warning is issued in order to indicate immediate—or anticipated (within a few seconds, minutes or hours)—noncompliance. The monitoring system may also rely on a flight plan or path derived from a computation by the flight management system (see 350).

In terms of hardware, the implementations of the invention may be various (onboard and/or on the ground, etc.). In terms of hardware, the embodiments of the invention may be produced by computer, for example. Alternatively, a distributed architecture of “cloud computing” type may be used. Fully or partially distributed (existence of centers) peer-to-peer servers may interact. The invention may be apportioned between an onboard domain and a non-onboard domain (onboard or even on the ground). One or more databases may be used, centralized and/or distributed.

In one embodiment, regarding terrestrial or maritime movements, the path and traffic management computers may be called upon, coupled to a visual display system. In the orbital case, path management may be coordinated at international level and/or may comprise peer-to-peer control. The management of satellite constellations may implement one or more steps of the method according to the invention, in particular 3D display in virtual reality.

In one embodiment, an aircraft or mobile drone is equipped with a module for communication and collaborative sharing of data derived from the computers aboard the aircraft. This hardware module may be related to various users (consumers) and/or providers (producers) of data. Avionic equipment may interact (two-way communication) with non-avionic equipment. In some cases, communications may be one-way (from avionics to non-avionics (but not the other way round, i.e. in order to avoid introducing erroneous or malicious data from the open world into the certified avionics world)). Flight management systems FMS may be networked to one another, and also to EFBs.

1. A computer-implemented method for interactively managing an occupied space around a mission path of a vehicle, the method comprising steps carried out between a human-machine interface and a path computing system, and consisting at least in:
using the HMI to define parameters for a mission of a vehicle;
using the path computing system to compute an occupation geometry from said parameters, the computed occupation geometry corresponding to a potential occupation space around a planned path of the vehicle during the mission;
using the HMI to display said potential occupation space; and
using the HMI to confirm said potential occupation space; or
repeating the above steps with new mission parameters.

2. The method as claimed in claim 1, implemented in order to interactively manage an occupied airspace around a path of an aircraft, comprising the steps of:
firstly:
receiving or determining a flight plan of the aircraft, associated with a mission; and
determining a potential occupation airspace associated with the flight plan;
and secondly:
gathering spatial, temporal or technical constraints relating to the spatial congestion within the determined potential occupation airspace;
displaying the received or determined flight plan and the data relating to the spatial congestion in the human-machine interface; and
determining a flight plan or a flyable path as permitted by the path computing system, and the occupied airspace.

3. The method as claimed in claim 2, further comprising steps of:
adjusting the potential occupation airspace on the basis of interactions received by way of said human-machine interface and/or on the basis of changes of flight plan or path that are determined in or by the path computing system; and
displaying one or more flown or flyable airspaces.

4. The method as claimed in claim 1, further comprising a step of monitoring the movements of the occupied space.

5. The method as claimed in claim 2, further comprising a step of providing a warning in the event of the flight of the aircraft straying outside the determined occupied airspace.

6. The method as claimed in claim 2, further comprising a step of displaying a flight plan of the aircraft and the occupied airspace associated with said flight plan in a superimposed manner.

7. The method as claimed in claim 1, wherein the vehicle is an aircraft, the method further comprising a step of changing an airspace associated with the aircraft, on the basis of changes of paths of the aircraft and/or on the basis of continuously received data, said data comprising critical weather data, dangerous subairspaces to be avoided or rejoined, safe or authorized subairspaces and/or statutory constraints, in particular “RNP” performance-based navigation-type containment criteria.

8. The method as claimed in claim 1, wherein the following are displayed in a human-machine interface:
one or more of the intermediate computing results concerning in particular a flight plan, a path and an airspace; and/or
information relating to the root causes and/or the computing context of one or more of the steps of the method.

9. A computer program product, said computer program comprising code instructions allowing the steps of the method as claimed in claim 1 to be performed when said program is executed on a computer.

10. A system for interactively managing an occupied space around a mission path of a vehicle, comprising:
a human-machine interface configured to display lateral and/or vertical information in 2D, 3D or 4D;
a path computing system coupled to said human-machine interface; and
computing resources for implementing the steps of the method as claimed in claim 1.

11. The system as claimed in claim 10, further comprising a circuit and/or computing and/or memory resources, said resources being local and/or accessed remotely.

12. The system as claimed in claim 10, the path computing system being an onboard and avionic flight management system and/or a flight management system of open world type, in particular of electronic flight bag EFB type.

13. The system as claimed in claim 10, the human-machine interface comprising a navigation screen of “ND” type.

14. The system as claimed in claim 11, the human-machine interface comprising one or more, virtual or augmented reality, screens configured to visually display data in 2D, 3D and/or 4D.

15. The system as claimed in claim 11, further comprising one or more blockchains and/or smart contract chains configured to manage the air traffic, the weather or the spatial congestion around the path of an aircraft.
